(19) United States
(12) Patent Application Publication
(10) Pub. No.: US 2024/0181997 A1
(43) Pub. Date: Jun. 6, 2024

(54) CAMERA NOZZLE ASSEMBLY

(71) Applicant: A. RAYMOND ET CIE, Grenoble (FR)

(72) Inventors: Larry Rachow, Lenox, MI (US); James Mell, Chesterfield, MI (US); Mark Beyer, Armada, MI (US); Kevin Bond, Brownstown Township, MI (US)

(21) Appl. No.: 18/286,442

(22) PCT Filed: Apr. 14, 2022
(86) PCT No.: PCT/IB2022/053546

§ 371 Date: Oct. 11, 2023

Related U.S. Application Data
(60) Provisional application No. 63/175,085, filed on Apr. 15, 2021.

(51) Int. Cl. B60S 1/56; B60S 1/52; B60S 1/54; G02B 27/00; H04N 23/51; H04N 23/81

(52) U.S. Cl. CPC B60S 1/56; B60S 1/52; B60S 1/54; G02B 27/0006; H04N 23/51; H04N 23/811

(57) ABSTRACT

A camera nozzle assembly (100) for cleaning a camera lens is provided. The camera nozzle assembly includes a bracket mount (110) and a nozzle assembly (120). The bracket mount includes a camera aperture (146) for the camera lens and can be mounted to a vehicle. The nozzle assembly is joined to the bracket mount and includes a spray nozzle (160) and an air duct (154). The spray nozzle discharges a cleaning liquid, and the air duct discharges compressed air, each being discharged at a shallow angle relative to a camera lens. The cleaning liquid and the compressed air cooperate to remove foreign matter from the exterior surface of the camera lens, optionally for front-bumper cameras, side-view cameras, rear-bumper cameras, and cameras for semi-autonomous and autonomous operation of passenger vehicles, trucks, buses, and commercial vehicles.

### CROSS-REFERENCE TO RELATED APPLICATIONS

This application claims the benefit of U.S. Provisional Application 63/175,085, filed Apr. 15, 2021, which is hereby incorporated by reference in its entirety.

### FIELD OF THE INVENTION

The present invention relates to a camera nozzle assembly including an air duct and a fluid spray nozzle for cleaning a lens surface of a camera or a camera sensor.

### BACKGROUND OF THE INVENTION

Exterior cameras are widely used to enhance a driver's situational awareness and to improve safety. In addition to back-up cameras, which are required in the U.S. and Europe for newly manufactured vehicles, front-bumper cameras and side-view cameras allow the driver to see obstacles on a dashboard-mounted display screen. These cameras are typically mounted unobtrusively and are incorporated into existing features where possible to do so.

Exposure to the elements can affect the output of exterior cameras. For example, dust, mud, snow, ice, and salt can collect on the exterior surface of a camera lens and can affect how the driver perceives the exterior environment. The camera lens (typically a wide-angle lens) can be manually cleaned, but the camera lens may become obscured between departure and destination. Accordingly, it is generally desired to provide an automated system to periodically remove foreign matter from the exterior surface of a camera lens. Particularly as newer vehicles require continuous sensing from multiple cameras for semi-autonomous and autonomous operation, it is generally desired to provide a camera cleaning system that is compact and that is visually unobtrusive for ridding the exterior surface of a camera lens of foreign matter.

### SUMMARY OF THE INVENTION

A camera nozzle assembly for cleaning a camera lens is provided. The camera nozzle assembly includes a bracket mount and a nozzle assembly. The bracket mount includes a camera aperture for the camera lens and can be mounted to a vehicle. The nozzle assembly is joined to the bracket mount and includes a spray nozzle and an air duct. The spray nozzle discharges a cleaning liquid, and the air duct discharges compressed air, each being discharged at a shallow angle relative to a camera lens. The cleaning liquid and the compressed air cooperate to remove foreign matter from the exterior surface of the camera lens, optionally for front-bumper cameras, side-view cameras, back-bumper cameras, and cameras for semi-autonomous and autonomous operation of passenger vehicles, trucks, buses, and commercial vehicles.

In one embodiment, the camera nozzle assembly includes a nozzle assembly joined to a bracket mount. The nozzle assembly includes an upper nozzle body and a lower nozzle body. The upper nozzle body and the lower nozzle body cooperate to define the air duct. The upper nozzle body also includes a fluid spray nozzle for discharging a cleaning liquid onto the camera lens, the fluid spray nozzle being angularly offset from the air duct. The camera or a portion thereof is housed within the bracket mount, which includes a snap fit attachment or a fastener attachment for connection to a variety of interchangeable nozzle assemblies.

In some embodiments, the fluid spray nozzle is laterally offset from the air duct. The air duct directs compressed air along a first transverse axis, and the fluid spray nozzle directs a cleaning liquid along a second transverse axis, the second transverse axis being different from the first transverse axis. In still another embodiment, the fluid spray nozzle is centrally disposed within the air duct. The nozzle assembly can include a pass-through air conduit protruding from left and right sides of the lower nozzle body, and the upper nozzle body can be ultrasonically welded to the lower nozzle body. The nozzle assembly is removably attached to the bracket mount, such that it can be readily replaced with nozzle assemblies having a center orientation, left orientation, and/or right orientation. The nozzle assembly includes an optional heated nozzle outlet and includes an optional inline check valve for the fluid spray nozzle.

These and other features and advantages of the present invention will become apparent from the accompanying description of the invention, when viewed in accordance with the accompanying drawings and appended claims.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. In addition, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a perspective view of a camera nozzle assembly in accordance with a first embodiment.

FIG. 2 is an exploded view of the camera nozzle assembly of FIG. 1 illustrating a nozzle assembly having a spray nozzle on the right side of an air duct.

FIG. 3 is a perspective view of a camera nozzle assembly in accordance with a second embodiment.

FIG. 4 is an exploded view of the camera nozzle assembly of FIG. 3 illustrating a nozzle assembly having a spray nozzle on the left side of an air duct.

FIG. 5 is a perspective view of a camera nozzle assembly in accordance with a third embodiment.

FIG. 6 is an exploded view of the camera nozzle assembly of FIG. 5 illustrating a nozzle assembly having a spray nozzle within an air duct.

FIG. 7 is a perspective view of a camera nozzle assembly in accordance with a fourth embodiment.

FIG. 8 is an exploded view of the camera nozzle assembly of FIG. 7 illustrating a nozzle assembly having a spray nozzle above an air duct.

FIG. 9 includes multiple camera nozzle assemblies in combination with a blower bracket mount and an air conduit.

### DETAILED DESCRIPTION OF THE CURRENT EMBODIMENTS

As discussed herein, the current embodiments are directed to a camera nozzle assembly for cleaning the exterior surface of a camera lens. The camera nozzle assembly generally includes a bracket mount and a nozzle assembly. The bracket mount provides a housing for a camera and functions to join the nozzle assembly to a vehicle structure. The nozzle assembly includes a spray nozzle and an air duct. The spray nozzle discharges a cleaning liquid, and the air duct discharges compressed air, each being discharged at a shallow angle (e.g., less than 30 degrees) relative to the exterior surface of a camera lens. Each such feature of the camera nozzle assembly is discussed below.

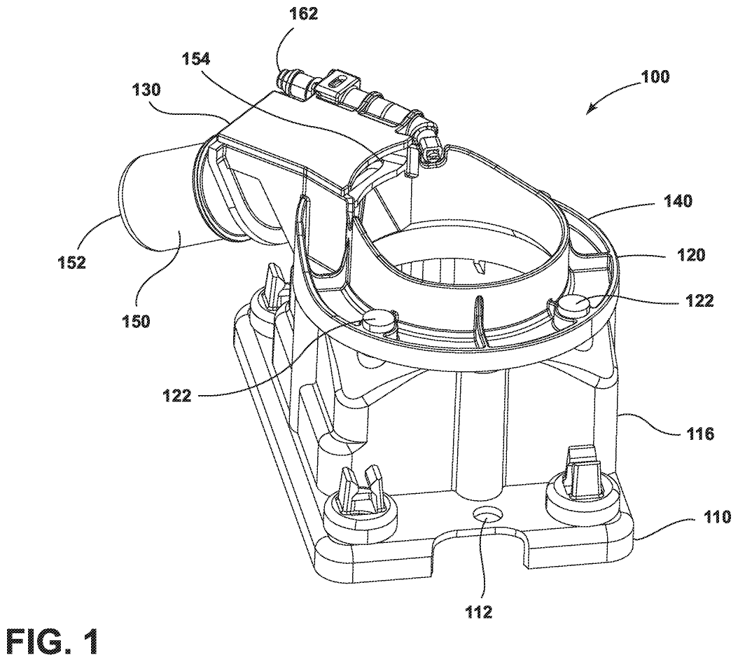

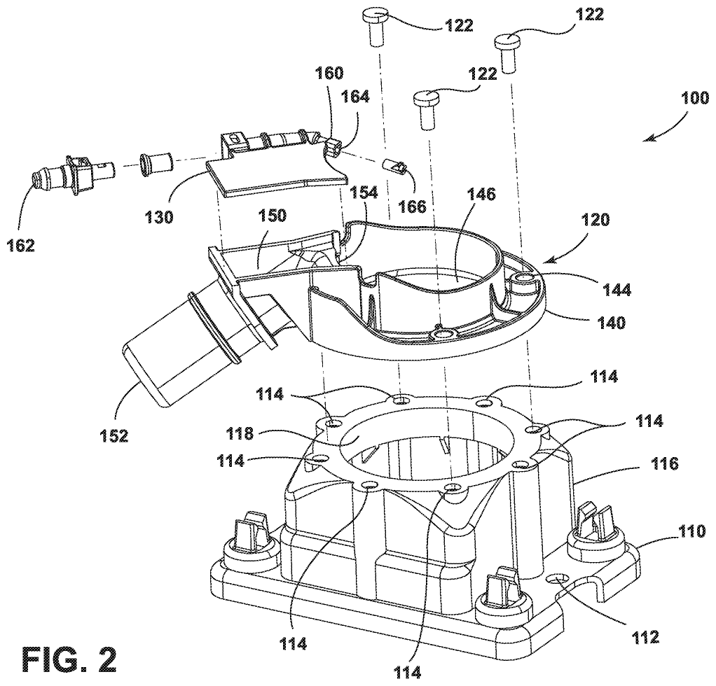

Referring first to FIGS. 1 and 2, a camera nozzle assembly in accordance with a first embodiment is illustrated and generally designated 100. The camera nozzle assembly 100 includes a universal bracket mount 110 for attaching a nozzle assembly 120 to a vehicle structure. The bracket mount 110 may be attached to the vehicle structure through any suitable method. In one embodiment, the bracket mount 110 is secured to the vehicle structure through mounting apertures using one or more fasteners. Various fasteners may be used including, for example, fir-tree connector clips or machine screws. The bracket mount 110 includes a sidewall 116 defining an interior cavity 118 for a camera. As depicted in FIGS. 1-2, the sidewall 116 is rectangular and the interior cavity 118 is cylindrical. In another embodiment, however, the sidewall 116 and the interior cavity 118 can have any other suitable shape.

As noted above, the nozzle assembly 120 is supported by the bracket mount 110. The nozzle assembly 120 may be supported by the bracket mount 110 in a variety of ways. As depicted in FIGS. 1-2, the nozzle assembly 120 can be secured to the bracket mount 110 through a plurality of fasteners 122 secured through attachment apertures 114, 144 in the bracket mount 110 and in a lower nozzle body 140. As depicted, the bracket mount 110 includes more attachment apertures 114 than the number of attachment apertures 144 in the lower nozzle body 140. The nozzle assembly 120 can be coupled to the bracket mount 110 through any of the attachment apertures 114 that align with the attachment apertures 144 in the lower nozzle body 140. This gives the camera nozzle assembly 100 rotational flexibility because the nozzle assembly 120 can be mounted to the bracket mount 110 in more than one orientation. For example, the nozzle assembly 120 may be mounted to the bracket mount 110 in a center orientation, a right orientation, or a left orientation. In one embodiment, the number of attachment apertures 114, 144 in the bracket mount 110 and the lower nozzle body 140 can be equal. The camera nozzle assembly 100 may also have rotational flexibility in this embodiment if the attachment apertures 114, 144 are arranged in such a way to allow for the nozzle assembly 120 to be mounted to the bracket mount 110 in more than one orientation. For example, the camera nozzle assembly 100 can have rotational flexibility if the attachment apertures 114, 144 are uniformly spaced from one another in the bracket mount 110 and the lower nozzle body 140. In one embodiment, the nozzle assembly 120 may be snap fit to the bracket mount 110 through the lower nozzle body 140. In one embodiment, a variety of configurations of nozzle assemblies can be supported by a given bracket mount 110.

The nozzle assembly 120 may be configured to provide an air duct and a spray nozzle to clean a lens surface. The nozzle assembly 120 can include an upper nozzle body 130 joined to the lower nozzle body 140. In one embodiment, the upper nozzle body 130 may be fixedly joined to the lower nozzle body 140. For example, the upper nozzle body 130 may be ultrasonically welded to the lower nozzle body 140. In one embodiment, the upper nozzle body 130 can be removably joined to the lower nozzle body 140. For example, the upper nozzle body 130 may be joined to the lower nozzle body 140 through at least one fastener that may be removed. In one embodiment, the nozzle assembly 120 can have a center orientation, a right orientation, or a left orientation. The lower nozzle body 140 can define a camera aperture 146 to at least partially surround the perimeter of a camera lens or other surface to be cleaned. In one embodiment, the camera aperture 146 may fully surround the perimeter of the surface to be cleaned. References are made throughout the disclosure to a camera lens, but it will be noted that this is intended to refer to any target surface to be cleaned.

As depicted in FIGS. 1-2, the upper nozzle body 130 and the lower nozzle body 140 can cooperate to define an air duct 150 that discharges air over the camera lens. The air duct 150 may alternately be referred to as an air nozzle. In one embodiment, the nozzle assembly 120 defines the air duct 150. In one embodiment, the upper nozzle body 130 can define the air duct 150. In another embodiment, the lower nozzle body 140 may define the air duct 150. The air duct 150 may guide air from an air inlet 152 to an air outlet 154 where the air is discharged over the camera lens. In one embodiment, the air outlet 154 can be laterally elongated, flared, or fan shaped to help evenly distribute the discharged air over the camera lens. In one embodiment, the air outlet 154 may be heated. The air duct 150 may be fluidly connected to an air supply. Put another way, the air inlet 152 can be connected to any suitable air source. In one embodiment, for example, the air inlet 152 can be connected to a pressurized air tank, either directly or through a conduit.

The upper nozzle body 130 may include a fluid spray nozzle 160 for discharging a cleaning liquid onto the camera lens. The cleaning liquid can alternately be referred to as a cleaning fluid. As depicted in FIGS. 1-2, the fluid spray nozzle 160 is disposed to the right side of the air outlet 154. Put another way, the depicted fluid spray nozzle 160 is laterally offset from the air duct 150 to the right. In one embodiment, the fluid spray nozzle 160 may be disposed adjacent the air duct 150 in a different location. In another embodiment, the fluid spray nozzle 160 may be disposed within the air duct 150. The fluid spray nozzle 160 can include a fluid inlet 162 and a fluid outlet 164. The fluid spray nozzle 160 guides the cleaning liquid from the fluid inlet 162 to the fluid outlet 164 where the cleaning liquid is discharged over the camera lens. The cleaning liquid can be any suitable cleaning liquid, including washer fluid. The fluid spray nozzle 160 can be fluidly connected to a cleaning liquid supply. Put another way, the fluid inlet 162 may be connected to any suitable cleaning liquid source. In one embodiment, the fluid inlet 162 can be connected to the vehicle's windshield washer fluid reservoir. The fluid spray nozzle 160 may be coupled to the upper nozzle body 130 in any suitable manner including, but not limited to, being coupled to the upper nozzle body 130 through a fastener and having at least a portion integrally formed with the upper nozzle body 130. In one embodiment, the fluid spray nozzle 160 includes an integrated inline check valve. In one embodiment, the fluid outlet 164 may be heated. The fluid spray nozzle 160 can include a spray chip 166. The spray chip 166 may assist the fluid spray nozzle 160 in covering the camera lens in cleaning liquid.

In one embodiment, compressed air from the air duct 150 may be used to clean the camera lens. In another embodiment, the cleaning liquid from the fluid spray nozzle 160 may be used to clean the camera lens. In another embodiment, both the air from the air duct 150 and the cleaning liquid from the fluid spray nozzle 160 can be used to clean the camera lens. The air duct 150 directs compressed air along a first transverse axis, and the fluid spray nozzle 160 directs a cleaning liquid along a second transverse axis. The second transverse axis is different from the first transverse axis, such that the air duct 150 and the fluid spray nozzle 160 are angularly offset from each other. For example, the second transverse axis can be angularly offset from the first transverse axis by between 20 and 90 degrees, inclusive, further optionally by between 30 degrees and 60 degrees, inclusive. The first transverse axis and the second transverse axis are oriented toward a geometric center of the camera aperture. When both the air duct 150 and the fluid spray nozzle 160 act to clean the camera lens, the air duct 150 and the fluid spray nozzle 160 may act in concert, sequentially, or a combination of both. In one embodiment, the nozzle assembly 120 can be configured to change the cleaning characteristics including air pressure, cleaning liquid pressure, discharge time, and discharge frequency.

Each of the embodiments described herein may contain some of the same or similar elements except where otherwise denoted. It will be noted that features described with respect to one embodiment can be included in other embodiments.

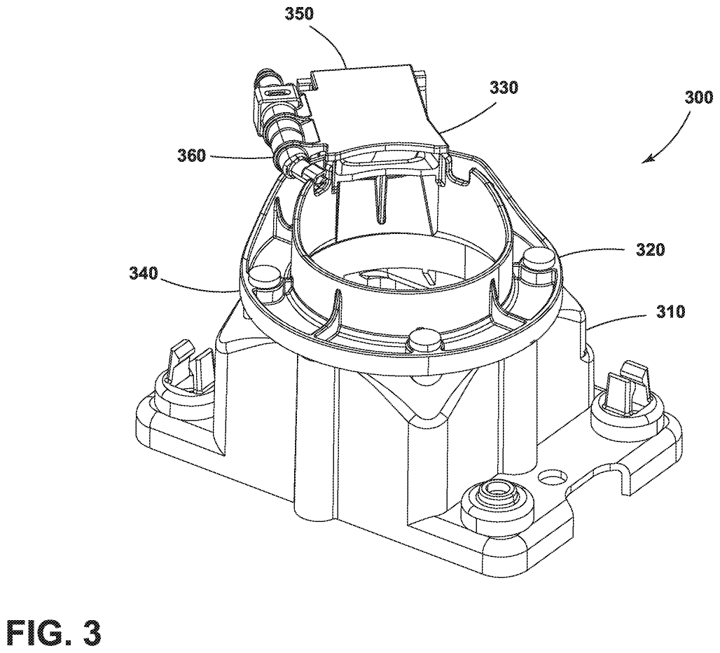

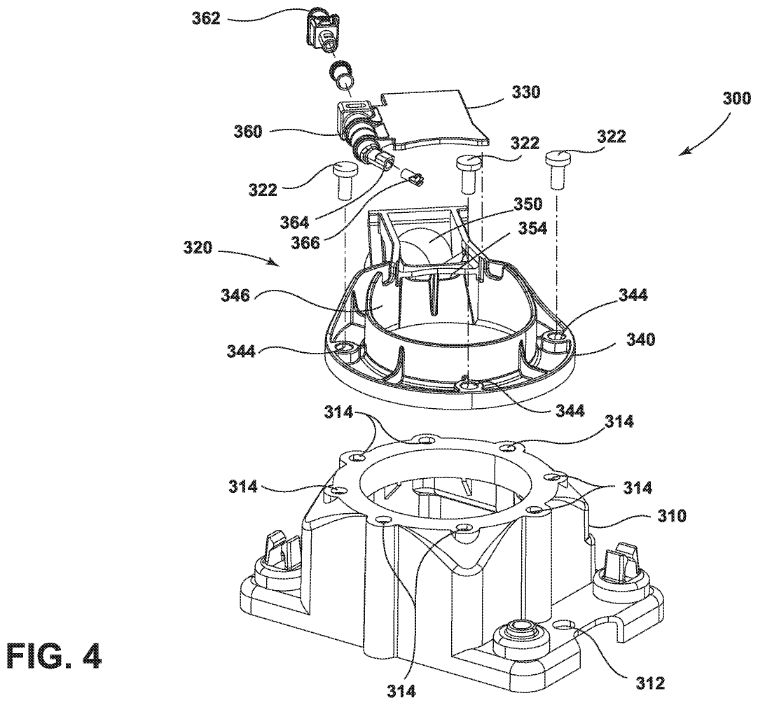

Referring now to FIGS. 3-4, a camera nozzle assembly in accordance with a second embodiment is illustrated and generally designated 300. The camera nozzle assembly 300 is similar to the camera nozzle assembly 100 of FIGS. 1-2, and like elements are referred to with the same reference numeral with a leading 3 instead of a leading 1 except as otherwise noted. The camera nozzle assembly 300 includes a bracket mount 310 and a nozzle assembly 320 supported by the bracket mount 310. The nozzle assembly 320 includes a lower nozzle body 340 and an upper nozzle body 330. The upper nozzle body 330 and the lower nozzle body 340 cooperate to define an air duct 350. The upper nozzle body 330 includes a fluid spray nozzle 360. As depicted, the fluid spray nozzle 360 is disposed adjacent the air duct 350 on the left, and the upper nozzle body 330 is otherwise identical to the upper nozzle body 130 of FIG. 1.

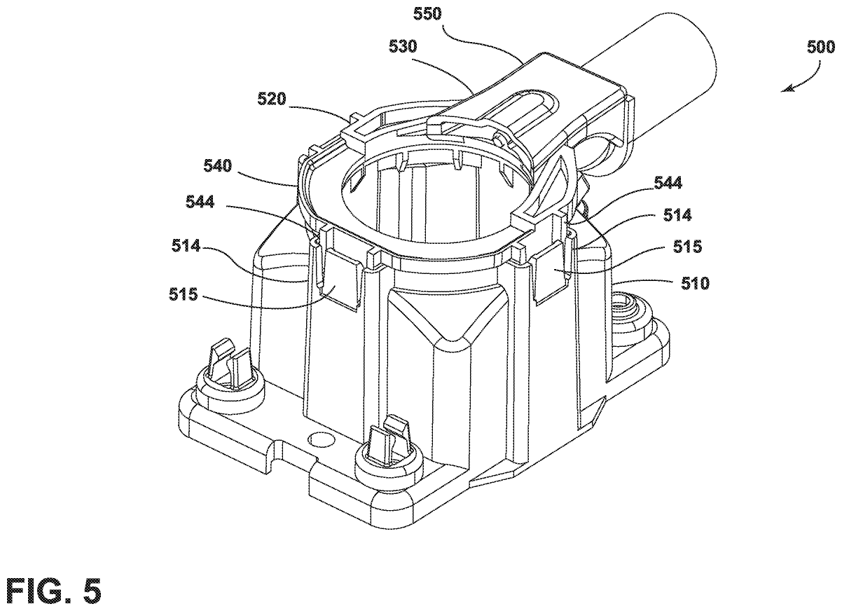

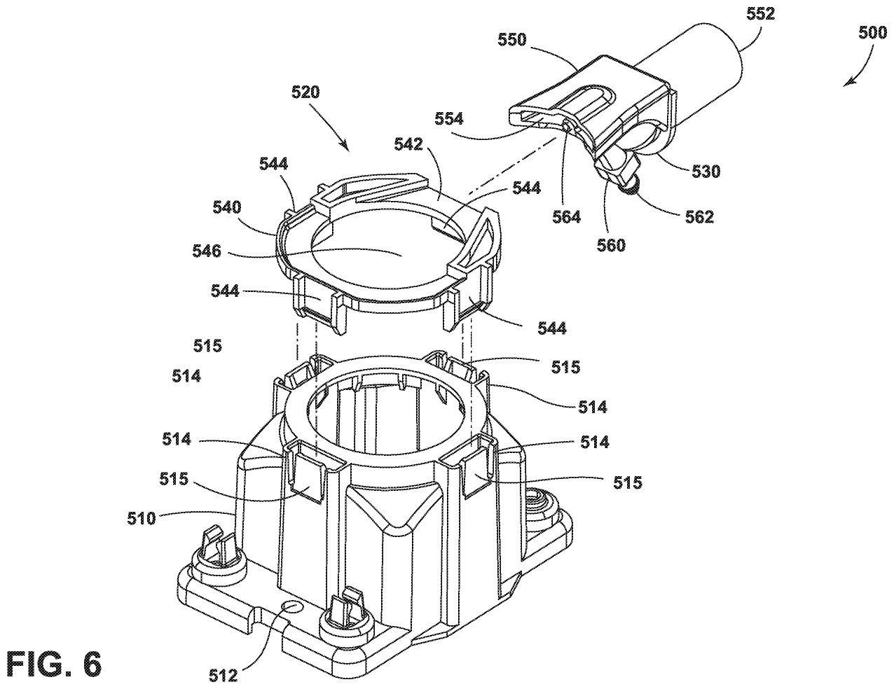

Referring now to FIGS. 5-6, a camera nozzle assembly in accordance with a third embodiment is illustrated and generally designated 500. The camera nozzle assembly 500 is substantially similar to the camera nozzle assembly 100 of FIGS. 1-2, and like elements are referred to with the same reference numeral with a leading 5 instead of a leading 1 except as otherwise noted. The camera nozzle assembly 500 includes a bracket mount 510 and a nozzle assembly 520 supported by the bracket mount 510. The nozzle assembly 520 includes an upper nozzle body 530 and a lower nozzle body 540. The lower nozzle body 540 can define at least one protruding edge 544 and the bracket mount 510 can include at least one snap in area 514. The protruding edges 544 and the snap in areas 514 may mate together to allow the lower nozzle body 540 to snap fit to the bracket mount 510. The snap fit between the lower nozzle body 540 and the bracket mount 510 has the advantage of not requiring fasteners, which reduces the risk of loose parts in the assembly. The snap in areas 514 can include a snap in tab 515 that is pushed forward as the lower nozzle body 540 is attached to the bracket mount 510 and the protruding edges 544 are inserted into the snap in areas 514. In one embodiment, the snap in tab 515 can be actuated to release the lower nozzle body 540 from the bracket mount 510. As depicted, the snap in tab 515 may be pulled outward to release the lower nozzle body 540 from the bracket mount 510. The lower nozzle body 540 can be snap fit to the bracket mount 510 in any suitable orientation. In one embodiment, the snap fit may be a multiple use snap fit. In another embodiment, the snap fit may be a permanent snap fit. In another embodiment, the lower nozzle body 540 can be attached to the bracket mount 510 through any other suitable means.

The upper nozzle body 530 is joined to the lower nozzle body 540. The upper nozzle body 530 may be joined to the lower nozzle body 540 by any suitable means. As depicted, the upper nozzle body 530 is joined to the lower nozzle body 540 via a mating surface 542. In one embodiment, the lower nozzle body 540 is configured to support the upper nozzle body 530. The upper nozzle body 530 can define the air duct 550. The air duct 550 includes an air inlet 552 and an air outlet 554 through which air is discharged over a camera lens.

The upper nozzle body 530 may include a fluid spray nozzle 560. The fluid spray nozzle 560 includes a fluid inlet 562 and a fluid outlet 564 through which cleaning liquid is discharged over the camera lens. As depicted, the fluid spray nozzle 560 is disposed within the air duct 550. Put another way, the fluid spray nozzle 560 is concentric with the air duct 550. In one embodiment, the fluid spray nozzle 560 may be integrated into the air duct 150. The fluid spray nozzle 560 guides cleaning liquid from the fluid inlet 562 to the fluid outlet 564. As depicted, the fluid inlet 562 is disposed lower than the fluid outlet 564.

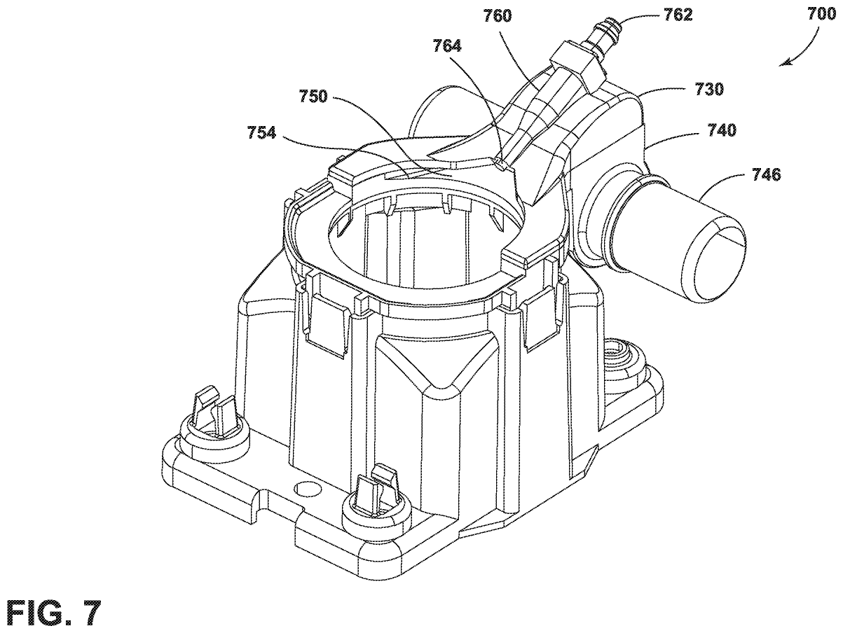

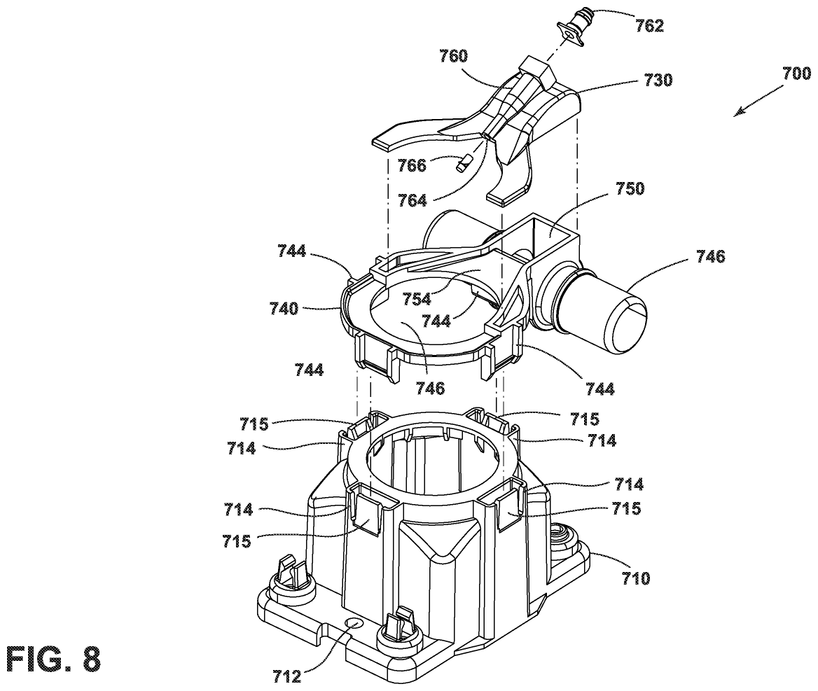

Referring now to FIGS. 7-8, a camera nozzle assembly in accordance with a fourth embodiment is illustrated and generally designated 700. The camera nozzle assembly 700 is substantially similar to the camera nozzle assembly 500 of FIGS. 5-6, and like elements are referred to with the same reference with a leading 7 instead of a leading 5. The lower nozzle body 740 may include a pass-through air conduit 746 extending laterally from the left and right side surfaces of the lower nozzle body 740. The pass-through air conduit 746 can allow air to bypass the air duct 750. The pass-through air conduit 746 may supply air to the air duct 750 to be discharged out the air outlet 754 onto the camera lens. The upper nozzle body 730 is joined to the lower nozzle body 740. In one embodiment, the upper nozzle body 730 may be welded to the lower nozzle body 740. The lower nozzle body 740 and the upper nozzle body 730 cooperate to define the air duct 750. The upper nozzle body 730 includes the fluid spray nozzle 760. As depicted, the fluid spray nozzle 760 is disposed adjacent the air duct 750 above the air duct 750. Put another way, the fluid spray nozzle 760 is center mounted above the air duct 750. The fluid spray nozzle 760 guides a cleaning liquid from a fluid inlet 762 to a fluid outlet 764. As depicted, the fluid outlet 764 is higher than the fluid inlet 762.

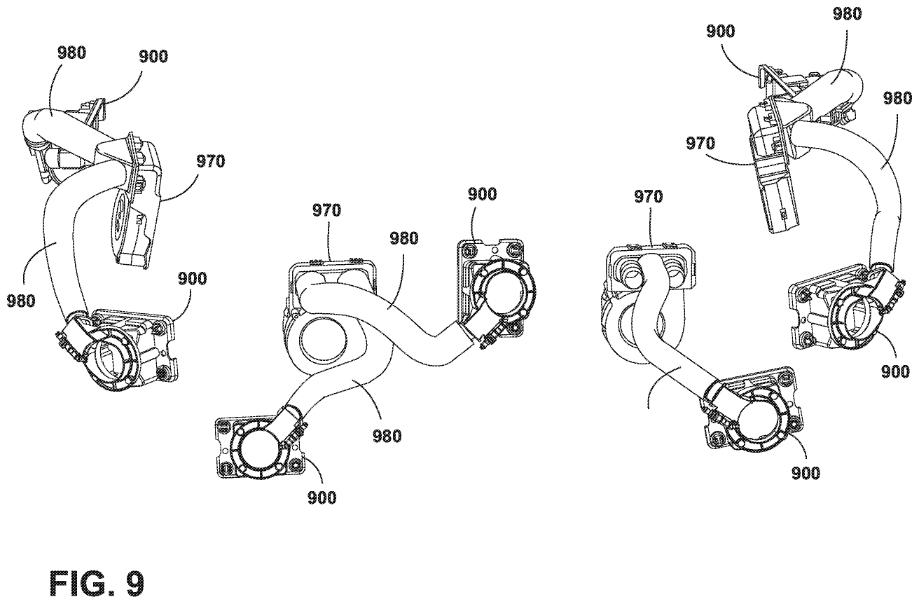

FIG. 9 depicts multiple camera nozzle assemblies 900 in combination with a blower bracket mount 970 and air conduit 980. In one embodiment, the assemblies depicted in FIG. 9 utilize quick connect fittings. The blower bracket mount 970 provides air to the air inlet of the camera nozzle assembly 900. There are many possible orientations of the camera nozzle assemblies 900, blower bracket mount 970, and air conduit 980, four of which are depicted in FIG. 9. In one embodiment, each blower bracket mount 970 may be connected to one camera nozzle assembly 900. In another embodiment, the blower bracket mount 970 can be connected to more than one camera nozzle assembly 900.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Features of various embodiments may be used in combination with features from other embodiments. Directional terms, such as “vertical,” “horizontal,” “top,” “bottom,” “front,” “rear,” “upper,” “lower,” “inner,” “inwardly,” “outer,” “outwardly,” “forward,” and “rearward” are used to assist in describing the invention based on the orientation of the embodiments shown in the illustrations. The use of directional terms should not be interpreted to limit the invention to any specific orientation(s). Any reference to claim elements in the singular, for example, using the articles “a,” “an,” “the,” or “said,” is not to be construed as limiting the element to the singular.

1. A camera nozzle assembly comprising:
a bracket mount for attachment to a vehicle structure; and
a nozzle assembly supported by the bracket mount and including an upper nozzle body joined to a lower nozzle body, wherein the upper nozzle body and the lower nozzle body cooperate to define an air duct that discharges air over a camera lens, and wherein the upper nozzle body includes a fluid spray nozzle for discharging a cleaning liquid onto the camera lens.

2. The camera nozzle assembly of claim 1, where the nozzle assembly is one of a plurality of different nozzle assemblies that are able to be joined to the bracket mount.

3. The camera nozzle assembly of claim 1, wherein the fluid spray nozzle is laterally offset from the air duct.

4. The camera nozzle assembly of claim 1, wherein the fluid spray nozzle is disposed within the air duct.

5. The camera nozzle assembly of claim 1, wherein the lower nozzle body includes a pass-through air conduit extending laterally from left and right side surfaces of the lower nozzle body.

6. The camera nozzle assembly of claim 1, wherein the upper nozzle body is ultrasonically welded to the lower nozzle body.

7. The camera nozzle assembly of claim 1, wherein the lower nozzle body includes a snap fit attachment to the bracket mount.

8. The camera nozzle assembly of claim 1, wherein the bracket mount includes a sidewall defining an interior cavity for housing a camera sensor therein.

9. A camera nozzle assembly comprising:
a bracket mount for housing a camera therein, the bracket mount including a camera aperture for a camera lens; and
a nozzle assembly joined to the bracket mount, wherein the nozzle assembly encircles the camera aperture and includes an air duct and a fluid spray nozzle, wherein the air duct directs compressed air along a first transverse axis, and wherein the fluid spray nozzle directs a cleaning liquid along a second transverse axis, the second transverse axis being different from the first transverse axis, such that the air duct and the fluid spray nozzle are angularly offset from each other.

10. The camera nozzle assembly of claim 9, wherein the second transverse axis is angularly offset from the first transverse axis by between 20 and 90 degrees, inclusive.

11. The camera nozzle assembly of claim 9, wherein the first transverse axis and the second transverse axis are oriented toward a geometric center of the camera aperture.

12. The camera nozzle assembly of claim 9, wherein the nozzle assembly includes an upper nozzle body and a lower nozzle body, wherein the upper nozzle body and the lower nozzle body cooperate to define the air duct, and wherein the upper nozzle body includes the spray nozzle.

13. The camera nozzle assembly of claim 12, wherein the upper nozzle body is ultrasonically welded to the lower nozzle body.

14. The camera nozzle assembly of claim 12, wherein the bracket mount defines a plurality of attachment apertures, and wherein the lower nozzle body mounts to the bracket mount through at least one of the attachment apertures.

15. A nozzle assembly for cleaning a camera lens, the nozzle assembly comprising:
an upper nozzle body; and
a lower nozzle body configured to support the upper nozzle body,
wherein the nozzle assembly is fluidly connected to an air supply and a cleaning liquid supply,
wherein the nozzle assembly defines an air duct that discharges air from the air supply over the camera lens, and
wherein the upper nozzle body defines a fluid spray nozzle that discharges a cleaning liquid from the cleaning liquid supply onto the camera lens.

16. The nozzle assembly of claim 15, wherein the upper nozzle body defines the air duct.

17. The nozzle assembly of claim 15, wherein the upper nozzle body and the lower nozzle body cooperate to define the air duct.

18. The nozzle assembly of claim 15, wherein the lower nozzle body includes a camera aperture and encircles the camera lens within the camera aperture.

19. The nozzle assembly of claim 15, wherein the fluid spray nozzle is laterally offset from the air duct.

20. The nozzle assembly of claim 15, wherein the fluid spray nozzle is disposed within the air duct.
